(19) United States
(12) Patent Application Publication
(10) Pub. No.: US 2010/0213175 A1
(43) Pub. Date: Aug. 26, 2010

(54) Diamond etching method and articles produced thereby

(75) Inventors: Hongying Peng, Niskayuna, NY (US); Mark Philip D'Develyn, Santa Barbara, CA (US); John William Nink, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/390,480

(22) Filed: Feb. 22, 2009

(51) Int. Cl. B44C 1/22; C23F 1/08

(52) U.S. Cl. 216/96; 156/345.1

(57) ABSTRACT

There are provided simplified methods for etching diamond, as compared to conventional methods. More particularly, the methods disclosed herein involve contacting at least a portion of the diamond with a metal or metal oxide so that redox etching of the contacted portion of the diamond occurs. Also provided are diamonds polished using the present method, as well as optical windows, heat sinks, cutting tools and electrical components incorporating diamonds polished/etched via the disclosed method.

### BACKGROUND

With its highest hardness and thermal conductivity among known materials, broad optical transparency from the ultra-violet (UV) to the far-infrared (IR), wide energy band gap (5.45 eV), chemical inertness and other unique physical properties, diamond is regarded as a desirable material for many applications including, of course, its use in gemstone applications, but also in wear-resistant cutting tools, heat sinks, high temperature electronic devices, and particularly, optical windows for visible and infrared transmissions. Use in the harsh environment of the latter application requires a unique combination of optical and physical properties.

In fact, diamond is a preferred material for optical windows since it exhibits only one narrow and moderate intrinsic absorption band between 4-5 μm or 2500-2000 cm⁻¹. At other wavelengths, almost all incident radiation is transmitted. Further, diamond has the highest thermal conductivity of any solid at room temperature (5 times that of Cu and typically over an order of magnitude higher than the majority of other materials) and also exhibits the lowest coefficient of thermal expansion than any other material. And so, diamond is particularly well suited for use in challenging environments.

Various devices use infrared (IR) sensors to receive signals for their control remotely, and this application in particular may require use of the IR sensor in such challenging environments. For example, IR sensors are commonly used in connection with devices that move at high speeds, such as aircraft and guided missiles. These devices and others traveling at high velocities expose the protective IR sensor windows to considerable heat loading and erosion due to the collisions with water drops or sand particles in the air. The heat demands coupled with the damage sustained from particle collisions with the windows can exceed the capabilities of windows that do not comprise diamond. Further, other materials, e.g., zinc sulfide, are highly susceptible to damage, since even the smallest atmospheric dust particles can scratch and otherwise have a considerable erosive effect, over time, on the optical transmissivity of components on objects moving at high speeds.

While diamond is thus particularly well suited for such applications, due to its extreme hardness and exceptional chemical inertness, diamond can be very difficult to process through traditional methods such as grinding or chemical etching, and in particular, can be difficult to process to the smoothness required for optical applications. Conventional methods of processing diamond fall mainly into three categories: physical mechanical polishing, graphitization followed by gasification, or carbon dissolution. All of these require either a unique grinding apparatus or a specific environment, such as vacuum, inert gas, or reducing gas, as well as a very high temperature in order to be effective. Such conventional polishing methods can represent over half the cost of a diamond optical window, e.g., a 4 inch diameter by 1 mm thick polished diamond optical window cost approximately $60,000 in 2006, with the polishing techniques accounting for about $10,000 to $30,000 of the overall cost.

Simplified, more cost effective, methods for etching diamond are thus needed. Desirably, such methods would be capable of providing diamonds having a roughness suitable for use in multiple applications including optical usage.

### BRIEF DESCRIPTION

A method for etching diamond is provided. The method comprises contacting the diamond with a metal or metal oxide so that redox etching of the contacted portion of the diamond occurs.

Also provided are diamonds polished using the present method, as well as optical windows, heat sinks and electrical components incorporating diamonds polished/etched via the disclosed method.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view of a submicron polished diamond prior to application of the method;

FIG. 2 is a cross-sectional view of the diamond shown in FIG. 1, after application of one embodiment of the disclosed method;

FIG. 3 is a flow-chart schematically illustrating one embodiment of the method described herein;

FIG. 4 is a flow-chart schematically illustrating another embodiment of the method described herein;

FIG. 5 is a flow-chart schematically illustrating another embodiment of the method described herein;

FIG. 6 is a flow-chart schematically illustrating a further embodiment of the method described herein;

FIG. 7 is a flow-chart schematically illustrating yet another embodiment of the method described herein; and

FIG. 8 shows a curved surface subject to redox etching illustrating yet another embodiment.

### DETAILED DESCRIPTION

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement ofthe particular quantity).

Provided herein are simplified methods for etching diamond relative to those provided by the prior art. More particularly, the methods disclosed herein involve contacting a diamond with a metal or metal oxide which is oxidizable in air and reducible by carbon, so that redox (shorthand for reduction-oxidation reaction) etching of the diamond contacted with the metal or metal oxide can occur. That is, one embodiment of the disclosed methods does not require application of a particular atmosphere, e.g., vacuum, inert protection gas, etc., or application of excessive temperatures, and thus, the methods are simple and cost-effective to implement. Further, the use of advanced, expensive etching techniques and/or equipment, e.g., corona discharge, electron beam, plasma, reactive ion etching, gas cluster ion beam, and the like, can be avoided. Yet, the methods described herein can achieve etch rates of diamond of from about 2 microns to about 5 microns per hour, which is similar to methods requiring contact of the diamond under a protective gas and/or at excessive temperatures, e.g., of greater than 1000° C.

A further embodiment employs the redox processing but with the introduction of atmospheres as known in the art as such processing may provide a further enhancement of the etch rate.

Any metal or metal oxide comprising elements which are oxidizable in air can be utilized in the disclosed method. Those having multiple oxides and/or easily reduced by carbon can be preferred in some embodiments of the method. The metal or metal oxide may or may not be capable of dissolving carbon. Examples of these include transition metals and noble metals, but are not limited to, zinc, copper, nickel, cobalt, iron, manganese, lead, vanadium, chromium, silver, cadmium, platinum, tungsten, mercury, tin, molybdenum, iridium, rhodium, ruthenium, palladium, cerium, and combinations of one or more of these. The rare earth metals and combinations thereof may also be utilized.

Such metals or metal oxides can provide for the “redox etching” of a diamond contacted by the metal and/or metal oxide(s). While not wishing to be bound by any theory, it is thought that the metals or metal oxides suitable for use in the method, engage in two relatively continuous cyclic reactions in order to etch the diamond, shown below using copper as an exemplary metal:

2Cu+O₂→2CuO [Oxidation] (i)

XCuO+C→XCu+COx [Reduction] (ii)

wherein X is 1 or 2. As such, it is thought that some portion of the metal or metal oxide particles in contact with the diamond will go through oxidation processes while others will be going through the reduction processes, relatively simultaneously. The result is that a relatively continuous redox etching process is provided, with an etch rate comparable to conventional processes, e.g., from about 2 microns to about 5 microns per hour. Further, since it is believed that the process is cyclic, the etch rate may not decrease substantially over time, as is the case with conventional carbon-dissolving methods.

Since the present method relies upon redox reactions, rather than physical mechanical polishing, graphitization, or carbon dissolution, a specific environment is not required, and the method disclosed herein can be carried out in an air atmosphere. Further, the high temperatures required by the aforementioned conventional methods need not be employed, i.e., the disclosed method can be carried out at temperatures of from about 400° C. to about 800° C. The particular temperature chosen will depend upon the metal chosen and the rate of etching desired.

The metal, metal oxide or combination thereof, may be provided in any suitable form, e.g., a powder, a thin film, grit, a wire, a foil, a plate, or other form. Desirably, the metal or metal oxide can be provided as a powder, in which case the finish provided to the diamond may advantageously be controllable by manipulation of the particle size, with fine particles with a size ranging from several nanometers to a few hundred nanometers utilized to provide a finer polish (e.g., a surface roughness in the range of from about 1 nm to about 100 nm) and coarse particles with a size ranging from about 0.1 μm to about 50 μm utilized to provide a coarser polish (e.g., a surface roughness in the submicrometer or micrometer range). Further, in those embodiments where a powder is used, the powder may be utilized dry, or mixed with a liquid to form a slurry.

Whatever the desired format, the metal, metal oxide, or combination is operatively disposed relative to the diamond to be etched. If a powder, grit or slurry, the metal, metal oxide or combination may be dispersed across the surface of the diamond or diamond plate. If provided in the form of a slurry, the liquid may be removed therefrom, if desired, by evaporation, either before, during or after etching. Wire or foil formats may be positioned with an end, edge, or plane thereof against the diamond, with a mild tensioning load applied to the wire, foil, and/or diamond to hold the wire or foil in place. Alternatively, a hole or slot may be provided to either partially or completely extend through the diamond, and the wire or foil positioned therein, either with or without application of a mild tensioning load to the diamond and/or wire or foil.

In one embodiment, only a portion of the diamond is contacted with the metal, metal oxide or combination. Further, the contact need not be uniform. However, diamond etching may not occur where there is no contact with the metal and/or metal oxide, and so, if planarization is desired, contact should be made with the defects desirably reduced or removed. A mixture of different sizes of metal or metal oxide particles can be utilized, if desired, to maximize the contact interface area. In one aspect, the use of different sizes of the metal or metal oxide particles can be performed serially by using larger size particles to provide a coarse etching and smaller sized particles to provide more refined etching until the desired planarization is achieved. The surface may be cleaned between the various applications. In another example different size particles can be combined to provide etching with the concentration of the different sizes set according to the application. For example, the number or concentration of larger size particles may be greater than the number of smaller particles so that the larger size protrusions are removed at a faster rate.

The diamond and the desired metal, metal oxide or combinations are desirably subjected to a temperature of from about 400° C. to about 800° C. in an air atmosphere. The diamond and metal, metal oxide or combination may be placed in a chamber, or may be placed on a supportive plate, capable of being heated to the desired temperature. Whatever environment is chosen, it may be preheated prior to introduction of the diamond, or, may be raised to the desired temperature once the diamond is introduced therein. Further, the diamond and metal, metal oxide or combination, may be operatively disposed relative to one another prior to introduction into the desired environment, or after.

Because the disclosed method does not require the use of advanced surface treatment techniques, e.g., corona discharge, electron beam, plasma, reactive ion etching, gas cluster ion beam, and the like, it is simplified, and capital costs associated with its implementation, are reduced relative to conventional processes. Further, because the use of excessive temperatures is avoided, energy costs may also be saved. The ability to carry out the method in an air atmosphere provides further simplification, as well as capital and short term expense savings.

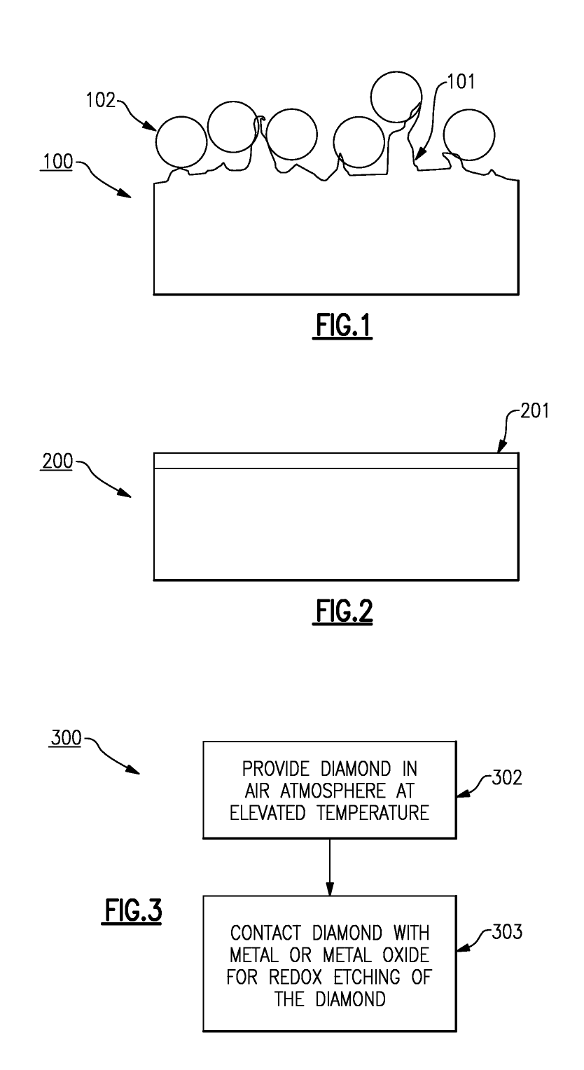

According to one embodiment, the diamond undergoes some initial pre-processing or preparatory steps. The diamond may be subjected to cleaning with a wet chemical etch and then preformed with laser cutting to provide the desired configuration, depending on the contemplated application. Once cut, the diamond may be subjected to a rough bulk polish, typically using cast iron impregnated or metal bonded diamond wheels. A sub micron grit polish may then be applied, typically by utilizing a single or double sided polishing process with diamond slurry or diamond impregnated wheels. After rough bulk polishing, the diamond may be expected to exhibit parallelism of about 2-8 Arc/mins, flatness of about 0.25-0.75/lambda and roughness of about 100 nm. After sub micron polishing, the same diamond will likely exhibit parallelism of about 10-50 Arc/sec, flatness from about 0.10-0.25/lambda and roughness of about 50 nm. A typical diamond having been subjected to rough bulk polishing and sub micron polishing is shown in cross-section in FIG. 1.

As shown, diamond 100 polished to the submicron level will typically still comprise spikes 101 on a surface thereof. The dimensions of the spikes 101 are related to the roughness levels seen, e.g., about 500 nm. Diamond surfaces exhibiting such roughness are suboptimal for use in many applications, including optical windows, heat sinks, and in electrical applications.

In this example, a number of particles 102 are shown that make contact with the surface spikes 101. The size and quantity of the metal/metal oxide particles 102 are presented for illustrative purposes only. In certain applications the size of the spikes are used to determine the optimal size of the particles so that the etching is concentrated on etching the spikes 101 as efficiently as possible while minimizing the etching of the entire surface. While the particles 102 are all approximately the same size in this example, other size particles can be employed in combination or serially. There may be more than a single application of the different sized particles in order to meet the planarization criteria. FIG. 2 shows a planarized diamond substrate 200 with the planar surface 201 resulting from the processing detailed herein.

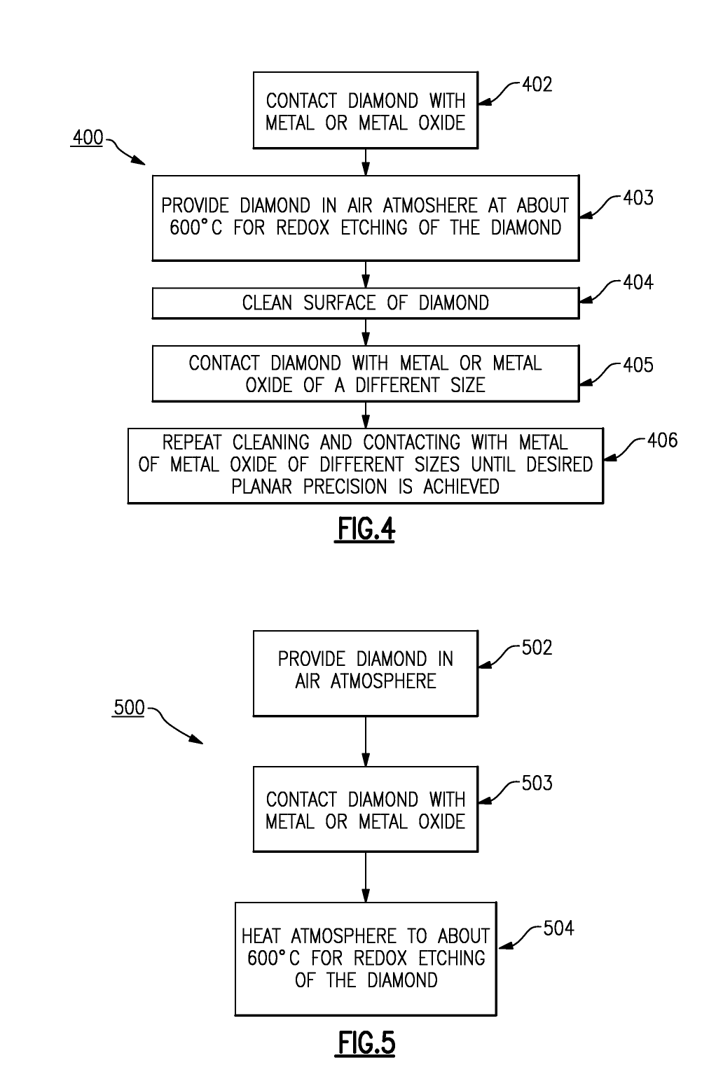

In FIG. 3, a flow chart schematically illustrating one embodiment of the present method 300, the provision of the diamond in an air atmosphere at an elevated temperature is shown in a first step 302. Desirably, the air atmosphere will be at a temperature of from about 400° C. to about 800° C. The diamond is then contacted with the desired metal, metal oxide or combination thereof at a second step 303, so that redox etching occurs within contact area. The desired metal, metal oxide or combination may be in any form, i.e., may be a dry powder, a powder provided in combination with a liquid, i.e., a slurry, a thin film, grit, a wire, a foil, a plate, or other form. Further, the metal, metal oxide or combination may be caused to contact the diamond via simple placement, e.g., advanced deposition techniques are not required. Whatever metal, metal oxide or combination chosen, and however placed relative to the diamond, the metal, metal oxide or combination will desirably be provided in an effective amount to substantially cover the portion of the diamond to be etched. Application of the method disclosed herein is expected to result in etch rates of from about 2 microns to about 5 microns per hour.

Upon the processing such as shown in FIG. 3, the diamond surface is now presented in a more suitable form for those applications requiring a more refined surface as shown in FIG. 2. The spikes and valleys from FIG. 1 have essentially been eliminated or reduced to such a low level as to be effectively removed, wherein the surface perturbations or non-uniformity in one embodiment is less than about 50 nm across the planarized section subjected to the redox etching.

FIG. 4 shows an alternative embodiment of the method, wherein the diamond is contacted with the desired metal, metal oxide or combination at first step 402 prior to being provided in the desired air atmosphere. The diamond is then placed in the desired atmosphere at step 403. In the embodiment shown in FIG. 4, the atmosphere may be heated to the desired temperature, e.g., 600° C., prior to the introduction of the diamond, although it is to be understood that, in other embodiments, the atmosphere may be heated after placement of the diamond. Contact with the metal or metal oxide, at the desired temperature, results in the redox etching of the portion of diamond so contacted with the metal, metal oxide or combination.

Depending upon the criteria requirements for the diamond substrate, additional planarizing may be needed. There are various instruments for determine whether the planar surface is within the limits of parallelism and roughness required for the desired application. The measurement of the surface roughness can also be used to determine the particle size for the redox etching. If smother surface is desired or required, additional steps of contacting the diamond surface with the metal or metal oxide can be performed. Optionally, and as shown at third step 404, the diamond surface may be cleaned prior to any such additional redox etching steps, i.e., as by contact with additional metal or metal oxide at fourth step 405. The optional cleaning step 404 and the subsequent contacting of the diamond surface with the metal or metal oxide 405 can be repeated until the surface roughness requirements are satisfied, as shown at step 406.

Yet another embodiment 500 of the disclosed method is schematically illustrated in the flow chart shown in FIG. 5. In this embodiment, the diamond is provided in the air atmosphere at first step 502, and then contacted with the desired metal, metal oxide, or combination at second step 503. The atmosphere is then heated to about 600° C. to effectuate redox etching of the diamond at third step 504.

FIG. 6 is a schematic illustration of yet another embodiment 600, wherein at a first step 602, a diamond is provided in an air atmosphere at an elevated temperature. At second step 603, the diamond is contacted with the desired metal, metal oxide or combination. Any metal or metal oxide easily oxidized in air, preferably capable of forming multiple oxides and that can be reduced by carbon may be used, and examples of these include zinc, copper, nickel, cobalt, iron, manganese, lead, vanadium, chromium, silver, cadmium, platinum, tungsten, mercury, tin, molybdenum, iridium, rhodium, ruthenium, palladium, cerium, and combinations of one or more of these. The rare earth metals and combinations thereof may also be utilized.

Once the desired amount of diamond surface material has been removed via the redox etching so provided, the diamond is removed from the air atmosphere and subjected to post-processing at third step 604. Step 604 may, for example, involve processing steps to provide a complete semiconductor device, e.g., the etched diamond may be subjected to boron or nitrogen ion implantation etc. to provide a suitable p-type or n-type doping level and junction formation etc. to form functional devices. In another embodiment, step 604 may involve processing steps to provide a complete optical window, e.g., the etched diamond may have anti-reflection coating applied thereto, or be bonded, and hermetically sealed, with metal frames, or other polished diamonds in order to provide a larger window.

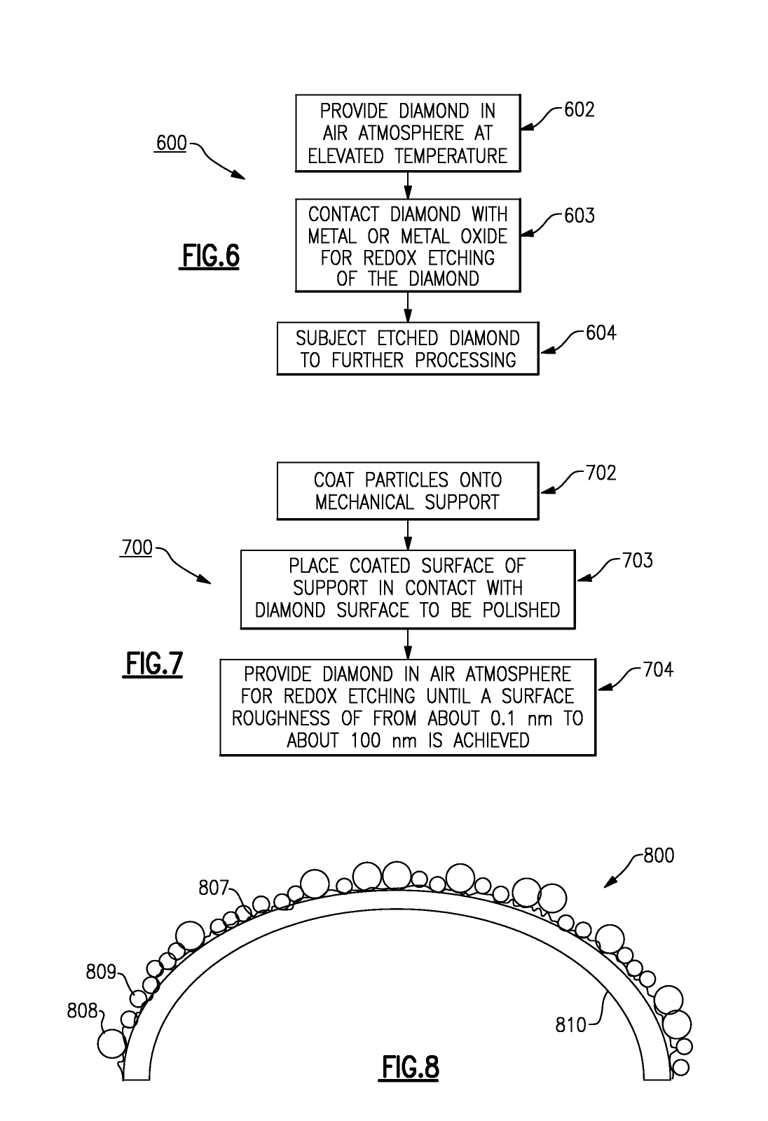

FIG. 7 is a schematic illustration of another embodiment 700, wherein at a first step 702, nanosized metal or metal oxide particles will be coated onto a mechanical support for the metal or metal oxide particles. The support desirably comprises a material able to retain its flatness and other supportive characteristics at elevated temperature during the later diamond etching process. For example, the support may comprise a fine polished ceramic, such as those comprising silica or alumina, disc or frit.

As with those embodiments where the metal or metal oxide is coated directly onto the diamond surface to be etches, any suitable method may be utilized to deposit the particles on the mechanical supportive substrate at step 702. For example, physical vapor deposition techniques such as evaporation, sputtering, laser ablation or electron beam deposition etc. can be used to coat a very thin layer metal film on the substrate or surface to be treated that is then subsequently cooled or quenched so that the metal film provides metal nanoparticles on the desired surface. Or, the metal or metal oxide particles may be provided directly on the desired surface, e.g., by chemical vapor deposition, electroplating, or electrophorosis methods.

As shown in second step 703, the coated support surface would then be put into contact with a diamond surface to be polished or planarized according to the disclosed method. Due to the flatness of the substrate and the nanometer size of the particles, the peaks of the rough diamond surface will be in contact with the metal or metal oxide particles first and thus etched first. As the diamond surface is planarized, the peaks will be removed and the valleys of the rough diamond surface will be reached. At third step 704, the support diamond is placed in an air atmosphere, that may desirably heated to a temperature of from about 400° C. to about 800° C., for the desired period of time, until the desired planarization has been achieved. As discussed above, selection of particle size of the metal or metal oxide can be utilized to provide a particular level of surface roughness, and surface roughnesses in the submicron or micron level, as well as the nanometer level, can be provided.

The redox etching method provided herein is capable of producing diamonds having a surface roughness of less than about 50 nm, at a substantially reduced cost relative to conventional methods, e.g., those relying upon physical mechanical polishing, graphitization, or carbon dissolution. As a result, the disclosed method may be utilized to provide polished diamonds useful for a variety of applications, where the advantageous cost savings provided by the method may be carried forward to the diamond, e.g., optical windows, produced with the redox polished diamond. And so, also contemplated herein are polished diamonds provided by the redox etching method, and optical windows, electrical components and heat sinks comprising the same.

Yet a further embodiment provides for polishing of diamond substrates 800 with curved surfaces, such as curved exterior surface 807. Such curved or nonlinear surfaces are used in certain applications such as spacecraft, missiles and military munitions. As shown, two different size particles 808 and 809 are used to etch away the outward or exterior surface. It is thus readily apparent that the redox etching may be utilized to planarize or polish, any desired surface, including nonlinear surfaces including the interior surface 810 of the substrate 800. The particles 801, 802 in this example etch away at the contact area with the particles. Curved and nonlinear surfaces tend to be more difficult than flat surfaces, thus the redox methodology teaches a more practical approach for etching.

While not exhaustive, certain examples are provided herein to show some of the many applications for which redox etching is applicable.

### EXAMPLE 1

A diamond film with dimensions of about 5 mm×9 mm×1.2 mm was placed on a aluminum oxide ceramic plate and contacted with approximately 10 g copper powder (99.5% pure, 325 mesh) at 600° C. in an air atmosphere for 10 hours. The weight of the diamond film prior to application of the method was 189.8 mg, and after application of the method was 185.9 mg. The method thus removed 3.9 mg of diamond in 10 hours.

### EXAMPLE 2

A diamond film with dimensions of about 3 mm×7 mm×0.8 mm was placed on a aluminum oxide ceramic plate and contacted with about 6 g of nickel powder (99.5% pure, 325 mesh) at 600° C. in an air atmosphere for 10 hours. The weight of the diamond film prior to application of the method was 54.6 mg, and after application of the method was 54.5 mg. The method thus removed 0.1 mg of diamond in 10 hours.

### EXAMPLE 3

A diamond film with dimensions of about 10 mm×20 mm×1.5 mm was placed on a aluminum oxide ceramic plate and contacted with about 18 g copper powder (99.5% pure, 325 mesh) at 570° C. in an air atmosphere for 10 hours. The weight of the diamond film prior to application of the method was 265.0 mg, and after application of the method was 263.5 mg. The method thus removed 1.5 mg of diamond in 10 hours.

### EXAMPLE 4

A diamond film with dimensions of about 5 mm×4 mm×2.0 mm was placed on a aluminum oxide ceramic plate and contacted with about 7 g of copper powder (99.5% pure, 325 mesh) at 600° C. in an air atmosphere for 20 hours. The weight of the diamond film prior to application of the method was 142.7 mg, and after application of the method was 138.3 mg. The method thus removed 4.4 mg of diamond in 20 hours.

### EXAMPLE 5

A diamond film with dimensions of about 5 mm×6 mm×0.8 mm was placed on a aluminum oxide ceramic plate and contacted with about 8 g of copper powder (99.5% pure, 325 mesh) at 600° C. in an air atmosphere for 40 hours. The weight of the diamond film prior to application of the method was 83.5 mg, and after application of the method was 71.2 mg. The method thus removed 12.3 mg of diamond in 40 hours.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for etching diamond comprising:
contacting at least a portion of the diamond with a metal or metal oxide so that redox etching of the contacted portion of the diamond occurs.

2. The method of claim 1, wherein the contacting occurs in an air atmosphere.

3. The method of claim 1, wherein the metal or metal oxide forms multiple oxides.

4. The method of claim 1, wherein the metal or metal oxide comprises zinc, copper, nickel, cobalt, iron, manganese, lead, vanadium, chromium, silver, cadmium, platinum, tungsten, mercury, tin, molybdenum, iridium, rhodium, ruthenium, palladium, cerium, or combinations of two or more of these.

5. The method of claim 1, wherein the metal or metal oxide comprises a powder, a thin film, grit, a wire, a foil, a plate, or combinations of these.

6. The method of claim 5, wherein the metal or metal oxide comprises a powder.

7. The method of claim 6, wherein the powder has a mesh size of less than about #500 mesh.

8. The method of claim 6, wherein the metal or metal oxide further comprises a liquid, and is provided in the form of a slurry.

9. The method of claim 5, wherein the metal or metal oxide comprises a wire, a foil, or a combination thereof and is positioned substantially normally to a surface of the diamond.

10. The method of claim 5, wherein the thin film is operatively disposed relative to a frit, and wherein the frit is used to etch at least a portion of the diamond.

11. The method of claim 10, wherein the frit is placed into lateral motion while etching said portion of the diamond.

12. The method of claim 1, wherein the contacting occurs at a temperature of from about 400° C. to about 800° C.

13. The method of claim 1, wherein the metal or metal oxide contains particles of at least one size.

14. The method of claim 13, further comprising more than one step of said contacting of the portion of the diamond with said particles.

15. An apparatus comprising a diamond, wherein at least a portion of the diamond has been etched by contacting the portion with a metal or metal oxide so that redox etching of the contacted portion of the diamond occurs.

16. The apparatus of claim 15, wherein the contact occurs in an air atmosphere.

17. The apparatus of claim 15, further comprising planarizing said contacted portion through said redox etching.

18. The apparatus of claim 15, wherein the metal or metal oxide comprises zinc, copper, nickel, cobalt, iron, manganese, lead, vanadium, chromium, silver, cadmium, platinum, tungsten, mercury, tin, molybdenum, iridium, rhodium, ruthenium, palladium, cerium, or combinations of two or more of these.

19. The apparatus of claim 15, wherein the metal or metal oxide comprises a powder, a thin film, grit, a wire, a foil, a plate, or combinations of these.

20. The apparatus of claim 15, wherein the apparatus comprises an optical window, an electrical component, a heat sink, a gemstone, or a cutting tool.
